(19) United States
(12) Patent Application Publication
(10) Pub. No.: US 2012/0278748 A1
(43) Pub. Date: Nov. 1, 2012

(54) Knowledge Dashboard for Knowledge Sharing and Management Applications

(75) Inventor: Lester S. Pierre, Valley Cottage, NY (US)

(73) Assignee: Wall Street Network, Inc.

(21) Appl. No.: 13/097,323

(22) Filed: Apr. 29, 2011

(51) Int. Cl. G06F 3/048

(52) U.S. Cl. 715/771

(57) ABSTRACT

A Knowledge Dashboard for use in a Knowledge Management application taking the form of user dashboards designed to help users of a Knowledge Management application within an organization to understand and become aware of the knowledge that is being distributed. The Knowledge Dashboard has the ability to inform a knowledge worker what the organization needs from that particular individual as well as pushing other users' knowledge and information to that individual. The Knowledge Dashboard forces corporate collaboration by pointing the user to the items which are determined to be the most important within the organization which the user should be contributing their insight and knowledge to. The Knowledge Dashboard eliminates the need to perform tedious searches of the knowledge and information gathered within a Knowledge Management application to determine what knowledge and information is important to the organization. The Knowledge Dashboard keeps individual users informed and allows the users to focus on what is important to the organization.

### BACKGROUND OF THE INVENTION

1. Field of the Invention

Organizations use a variety of Knowledge Management solutions to discover and maintain knowledge and new ideas which are useful, and in most cases, required for an organization's growth and well-being. Wikipedia defines Knowledge Management (KM) as “comprising a range of strategies and practices, including software systems and solutions, used in an organization to identify, create, represent, distribute, and enable adoption of insights and experiences. Such insights and experiences comprise knowledge, either embodied in individuals or embedded in organizational processes or practice.” These KM solutions typically take the form of posts within web logs (blogs) or online communities as well as conversations within software applications. However, the ability to navigate through the posts or conversations, as well as the feedback provided by other users to these posts or conversations is very difficult. A user must perform a variety of search functions in order to locate the information that is needed and may never find what they are looking for. Knowledge helpful to personnel within the organization may be overlooked, defeating the purpose of KM solutions.

The present invention is a Knowledge Dashboard which is a KM tool taking the form of a user dashboard designed to help individual users within an organization understand and become aware of the knowledge that is being distributed. The Knowledge Dashboard has the ability to inform a knowledge worker (typically an employee of an organization using a KM application) what the organization needs from that particular individual as well as pushing other's knowledge and information to that individual. The Knowledge Dashboard keeps individual users of a KM application informed and allows the user to focus on what is important within their organization because it shows the user what he or she should be looking at. The present invention forces corporate collaboration by making a user provide their insight and knowledge on topics important to the organization. The KM application containing the Knowledge Dashboard may utilize an Enterprise Content Management and Collaboration (ECMC) platform, which, in various implementations, may be MICROSOFT SHAREPOINT. In various implementations, the KM application containing the present invention may be WSN INSIGHT. WSN INSIGHT is a social networking tool for knowledge sharing and management among various groups of people, including personnel within an organization. This connects personnel inside an organization and allows each individual to place thoughts within the social network and create conversations targeting specific audiences within that organization. This allows personnel on all levels of an organization to share their knowledge and allows them to place their ideas somewhere outside of their mind where other members of the personnel can search for those ideas in the form of conversations. Users of such may create conversations around various topics and content which encompass their knowledge and ideas. Within WSN INSIGHT, conversations may be searched, tagged and published to target audiences and meeting spaces within the organization, making this particular KM application permissive based. Target audiences are the specific individuals the conversations are directed towards, and meeting spaces are groups of individuals, typically arranged by departments within an organization. Other users may then start their own conversations around these thoughts, or comment on other's conversations as feedback, rate the conversations or simply view the conversations that are directed towards the users, as users may only see the conversations they have been targeted for. Using this application, every member of an organization may share their thoughts and ideas.

The present invention displays the KM application's relevant conversations to users. The present invention contains several dashboards taking the form of Key Performance Indicators (KPI) which display conversations an individual user has permission to see; conversations the individual user was targeted for or a member of the meeting space in which the conversation was directed to. The dashboards within the Knowledge Dashboard displays conversation listings the user has access to, based on different criteria which may include the most popular conversations within the organization, conversations which are due for conclusion, conversations being tracked by the user as favorite conversations, conversations authored by the user which have concluded but have not been summarized by the user, conversations that the user has not viewed or participated in, and conversations containing recent activities. The Knowledge Dashboard and information contained in the dashboards is different for each user.

2. Description of the Prior Art

There are other applications designed for ease of user access to information contained in KM applications. Typical of these is U.S. Pat. No. 6,539,377 issued to Culliss on Mar. 25, 2003. Another patent was issued to Thota on Sep. 2, 2008 as U.S. Pat. No. 7,421,429. Yet another patent was issued to Forrest on Sep. 15, 2009 as U.S. Pat. No. 7,590,612.

### U.S. Pat. No. 6,539,377

### Inventor: Gary A. Culliss

### Issued: Mar. 25, 2003

A method of organizing information in which the search activity of previous users is monitored and such activity is used to organize articles for future users. Personal data about future users can be used to provide different article rankings depending on the search activity and personal data of the previous users.

### U.S. Pat. No. 7,421,429

### Inventor: Chandrasekhar Thota

### Issued: Sep. 2, 2008

A mechanism of ranking weblog or “blog” items is provided. More particularly, the subject ranking mechanisms can facilitate ranking blog feeds and blog items contained therein thus focusing and intelligently delivering content (e.g., blog items) to users. The subject innovation facilitates ranking the blog feeds and blog items by creating a context rank around each blog feed. The context rank represents a sum of a context weight, a track-back weight and a comment weight. Accordingly, this context rank can allow readers to sort blog items in the order of popularity or importance thus effectively reducing content noise.

### U.S. Pat. No. 7,590,612

### Inventor: Brady D. Forrest et al.

### Issued: Sep. 15, 2009

A blog map for searching and/or navigating the blogosphere is provided. In accordance with one method for generating a blog map, a number of blog posts within the blogosphere are accessed. Each of the blog posts is converted to a feature vector, which represents the position of the blog post in a high-dimensional space. The dimensionality of the feature vectors is reduced from the high-dimensional space to a low-dimensions space, such that each blog post is represented in the low-dimensional space. A map is then generated based on the position of the blog posts in the low-dimensional space.

### SUMMARY OF THE PRESENT INVENTION

The present invention relates generally to knowledge management solutions such as a social networking application for knowledge sharing and management, and more specifically to a Knowledge Dashboard for Knowledge Sharing and Management applications providing a solution whereby the user of such may access user-relevant conversations through various displays of dashboards containing conversations defined by different criteria without the hassle of searching through all the conversations that have been compiled within a knowledge sharing and management application.

A primary object of the present invention is to provide a Knowledge Dashboard for knowledge sharing and management applications where an individual user has the ability to navigate through pieces of knowledge within an organization which are important to the organization or user. This is where individual users within an organization can understand and become aware of the knowledge that is being distributed.

Another object of the present invention is to provide a Knowledge Dashboard for knowledge sharing and management applications where content and information is pushed to users informing the knowledge worker/employee of an organization, the user, what the organization needs from the user. The Knowledge Dashboard presents the most important knowledge, information and content gathered in the knowledge sharing and management application which are targeted to that specific user.

Yet another object of the present invention is to provide a Knowledge Dashboard for knowledge sharing and management applications where the most popular pieces of knowledge within an organization, taking the form of conversations, are listed for the user. The listed conversations are restricted to those that the user has access to.

Still yet another object of the present invention is to provide a Knowledge Dashboard for knowledge sharing and management applications where a user may filter the most popular conversations within an organization for specific use by the user.

Another object of the present invention is to provide a Knowledge Dashboard for knowledge sharing and management applications where conversations reaching its conclusion, or expiration date, are presented to the user for immediate action by the user.

Yet another object of the present invention is to provide a Knowledge Dashboard for knowledge sharing and management applications where conversations important to the user may be tracked by the user as favorites. A list of the user's favorite conversations are presented within the Knowledge Dashboard.

Still yet another object of the present invention is to provide a Knowledge Dashboard for knowledge sharing and management applications where conversations authored by the user receiving feedback from other users are presented which have reached its conclusion date. These conversations are listed to allow the user to summarize the feedback the user had been soliciting from other members of the organization.

Another object of the present invention is to provide a Knowledge Dashboard for knowledge sharing and management applications where conversations that the user has not participated in are presented. This allows the user to acknowledge that these conversations have not been given the user's attention.

Yet another object of the present invention is to provide a Knowledge Dashboard for knowledge sharing and management applications where conversations with recent activity by other members of the organization are presented.

The present invention overcomes the shortcomings of the prior art by providing a means for organizing popular and important knowledge within knowledge sharing and management applications. Nowhere in the prior art exits a Knowledge Dashboard having the ability to inform a user of a knowledge sharing and management application what their organization needs from them without having to search the knowledge sharing and management application. Each user has a Knowledge Dashboard specific to that user based on the conversations, or knowledge, that the user has permissions to see, which have been configured through the knowledge sharing and management application. The user has the ability to see how popular their accessible conversations are as conversations are weighted against all conversations within the application. The present invention gives the user the ability to see what conversations require his or her immediate attention as well as other configurable features including the date in which conversations are concluding, the ability to track conversations as favorites, the ability to see concluded conversations that the user has authored which have received feedback and need to be summarized, conversations that the user has be given access to but has not participated in by providing knowledge or feedback, and conversations with recent activity.

The foregoing and other objects and advantages will appear from the description to follow. In the description, reference is made to the accompanying drawings, which forms a part hereof, and in which is shown by way of illustration of specific embodiments in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts throughout the several views.

The following detailed descriptions is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a screen shot illustrating one example of the basic dashboards of the present invention;

FIG. 2 is a screen shot illustrating the dashboard for the popular conversations within a KM application within the present invention;

FIG. 3 is a flow diagram illustrating one example of how the Popular Conversations Dashboard determines the most popular conversations and content within the organization's KM application and places those items within the dashboard;

FIG. 4 is a screen shot illustrating one example of what the remaining dashboards for the present invention may look like; and

FIG. 5 is a flow diagram illustrating one example of how the dashboard categories are populated based on the organization configured criteria.

### DESCRIPTION OF THE REFERENCED NUMERALS

Turning now descriptively to the drawings, in which similar referenced characters denotes similar elements throughout the several views, the figures illustrate the Knowledge Dashboard for Knowledge Sharing and Management Applications of the present invention. With regard to the referenced numerals used, the following numbering is used throughout the various drawing figures.
10 Knowledge Dashboard for Knowledge Sharing and Management Applications of the present invention
14 popular conversations dashboard
16 tracking conversations dashboard
18 unsummarized conversations dashboard
20 concluding conversations dashboard
22 not participated or viewed conversations dashboard
24 recent activity conversations dashboard
26 filter
28 weighted popularity
30 title
32 update date
34 number of participation
36 status

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments; practitioners skilled in the art will recognize numerous other embodiments as well. For definitions of the complete scope of the invention, the reader is directed to the appended claims.

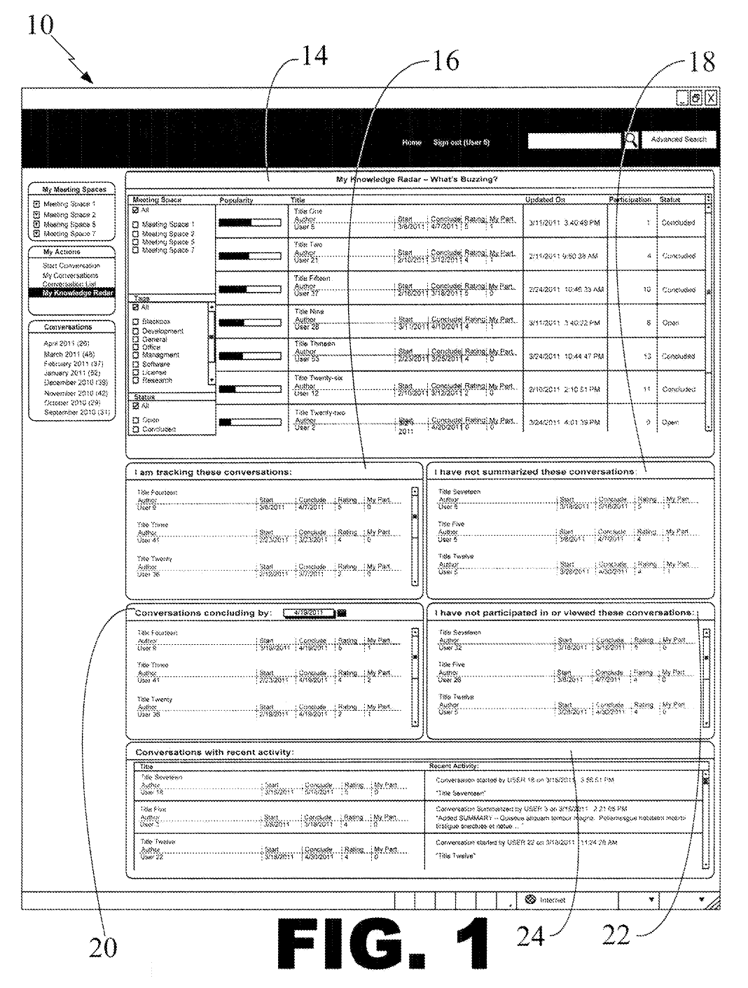

FIG. 1 is a screen shot illustrating one example of the basic dashboards of the present invention 10. The dashboards within the present invention may be built using various categorization or criteria including but not limited to the shown dashboards of the Popular Conversations Dashboard 14 showing the most popular conversations within a KM application, Tracking Conversations Dashboard 16, Unsummarized Conversations Dashboard 18, Concluding Conversations Dashboard 20, Not Participated or Viewed Conversations Dashboard 22, and Recent Activity Conversations Dashboard 24. These dashboards may be configurable based on an organization's preference for categorizations for the conversations that are presented in the present invention 10. For purposes of explanation, the above categorization shall be used in the illustration of the present invention. Each user has different conversations listed in the dashboards based on the permissions settings in a KM application. For example, WSN INSIGHT is permissive based meaning certain users may only see certain conversations that the user has privileges for. The present invention 10 lists the conversations in the dashboards distinguished from all the conversations within the KM application that the user has permission to view.

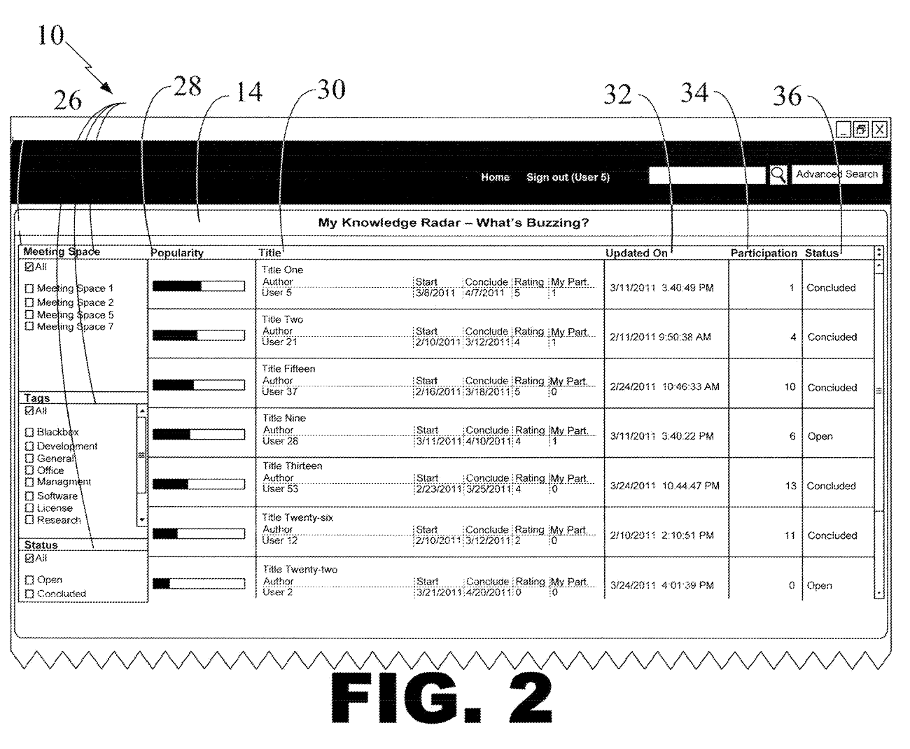

FIG. 2 is a portion of a screen shot illustrating the Popular Conversations Dashboard 14 within a KM application within the present invention 10. Shown are the configurable categories within the popular conversations for ease of use by the user. The configurable categories may include, but are not limited to, Filter 26, Weighted Popularity 28, Title 30, Updated Date 32, User Participation 34, and Status 36.

The Weighted Popularity 28 section, which is also the basis for the listing of the most popular conversations and content that have been directed to the user from within the KM application, shows the user how popular the conversations and content they have access to are across all the conversations and content within the organization's KM application. The basis for popularity is calculated against all of the conversations and content within the KM application. Popularity may be weighted and aggregated by three elements applied to every conversation within the KM application. These elements may include the amount of participations by users within the conversations, how many times the conversations have been viewed, and the ratings given by the viewers of the conversations. The organization may configure the weight, or numerical values, to apply towards these three elements for the determination for popularity. The total weight for the three elements always equals 100. For example, one organization may weigh level of participation more heavily than the remaining two elements and give the popularity a breakdown such as: Amount of participation=50, Amount of views=30, and Viewers ratings=20. These weights may be different for another organization that place heavier importance on the amount of views, or viewers' ratings. These weights are based on a recursive algorithm to be explained in further detail below.

Also shown in the Popular Conversations Dashboard 14 is the Filter 26. The Filter 26 is a way for the user to filter through the listed conversations within the Popular Conversations Dashboard 14. The Filter 26 applies to what the user is looking at and allows the user to see what he or she has access to. In this example, the user has the option to filter the listed conversations by meeting space, tags used by the various authors of the listed conversations, as well as whether the conversation is open for feedback or has been concluded. The Filter 26 may be configured based on the organization's needs. Once the Filter 26 categories are configured, each user has their own filter based on the conversations they have permissions to see.

The remaining configurable categories which are shown, here the Title 30, Updated Date 32, User Participation 34, and Status 36 gives the user statistics at a glance. The user may see items like who the authors of the popular conversations are, how many times the user actually participated in the conversations listed, the overall ratings given by other users that have access to the specific conversations, the time the last update was made by another user, and finally whether the conversations are open for feedback or if the conversations have concluded. These at a glance features allows the organization to fully use its KM application's potential by proactively pursuing every user's input. The conversations listed in the Popular Conversations Dashboard 14 gives the user an idea of what is important in the organization.

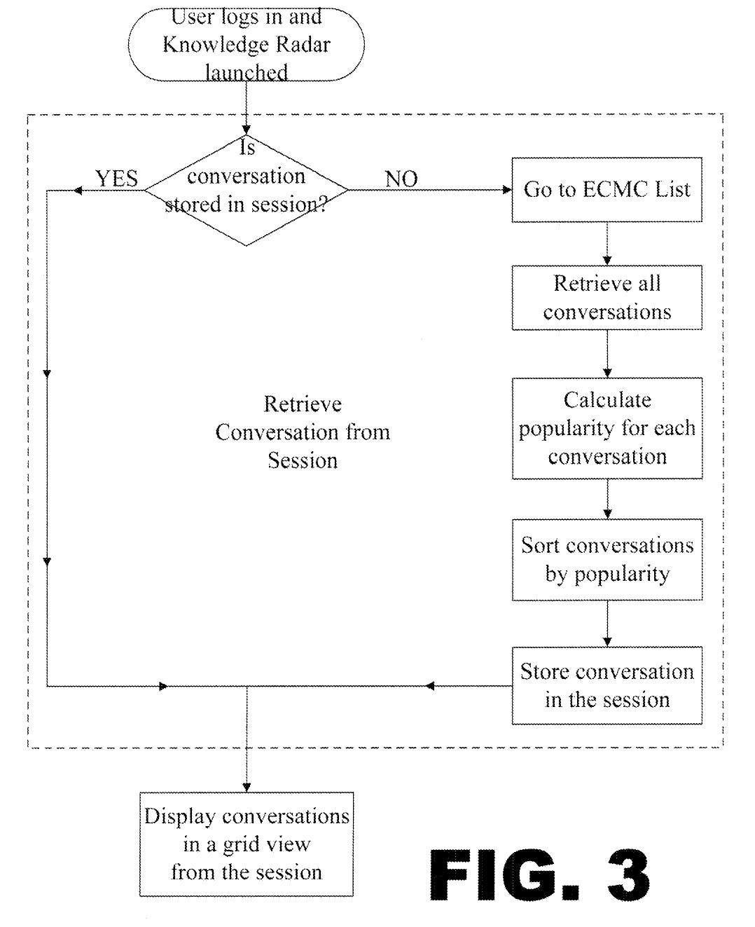

FIG. 3 is a flow diagram illustrating one example of how the Popular Conversations Dashboard determines the most popular conversations and content within the organization's KM application and places those items within the present invention. When the user logs into the KM application, the initial screen seen contains the Knowledge Dashboard. The process behind the determination of the most popular conversations within the KM application begins when the user logs into the KM application. The user first enters the KM application and the appropriate permissions are distinguished and the user accessible conversations are retrieved. The relevant information from these conversations are stored in memory, such as a data table within a session. In order to calculate the popularity of the conversations within a KM application, the system first determines whether or not the conversation was previously stored in a session. If the conversation was not stored, all conversations are retrieved from the ECMC list. In various implementations, the ECMC list may be a MICROSOFT SHAREPOINT list. Next, the popularity for each conversation is calculated.

In order to calculate the popularity for display in the present invention, conversations within KM applications are given three elements: Ratings, Number of Participation, and Number of Views. The determination for popularity for a conversation and content is calculated as follows:

Popularity for a conversation/content=Weight from Rating+Weight from Participation+Weight from Number of Views

As mentioned above, organizations may choose the weight allocated towards the elements used for calculating the popularity. For example, organization ABC's popularity can come from Rating valued at 50%, Participation valued at 30% and Number of Views valued at 20%. This may be different from organization XYZ. XYZ may have Rating valued at 34%, Participation valued at 33%, and Number of Views valued at 33%. This concept may be defined and configured by the organization as:

Rating_Score=x %

Participation_Score=y %

Read_View_Score=z % where x+y+z=100%

Furthermore, the maximum Rating is dependent upon the numerical values that conversations and content may be given within KM applications. For example, if the KM application is WSN INSIGHT, ratings are given a numerical value of 1, 2, 3, 4, or 5, 5 being the maximum Rating possible. The maximum Participation is the total number of participations for all conversations and content within the KM application. Maximum View is the total number of views for all the conversations and content within the KM application. Having all the above information, the following is true:

Weight from Rating=(Rating/Maximum Rating)*Rating_Score;

Weight from Number of Views=(Number of Views/Maximum Views)*Read_View_Score;

Weight from Participation=(Number of Participation/Maximum Participation)*Participation_Score

Therefore, as mentioned above, the following algorithm is used:

Popularity for a conversation/content=Weight from Rating+Weight from Participation+Weight from Number of Views

Once the popularity for each conversation has been calculated, the conversations are sorted by popularity and stored in the session. The conversations are then displayed in a grid view from the session in order of popularity.

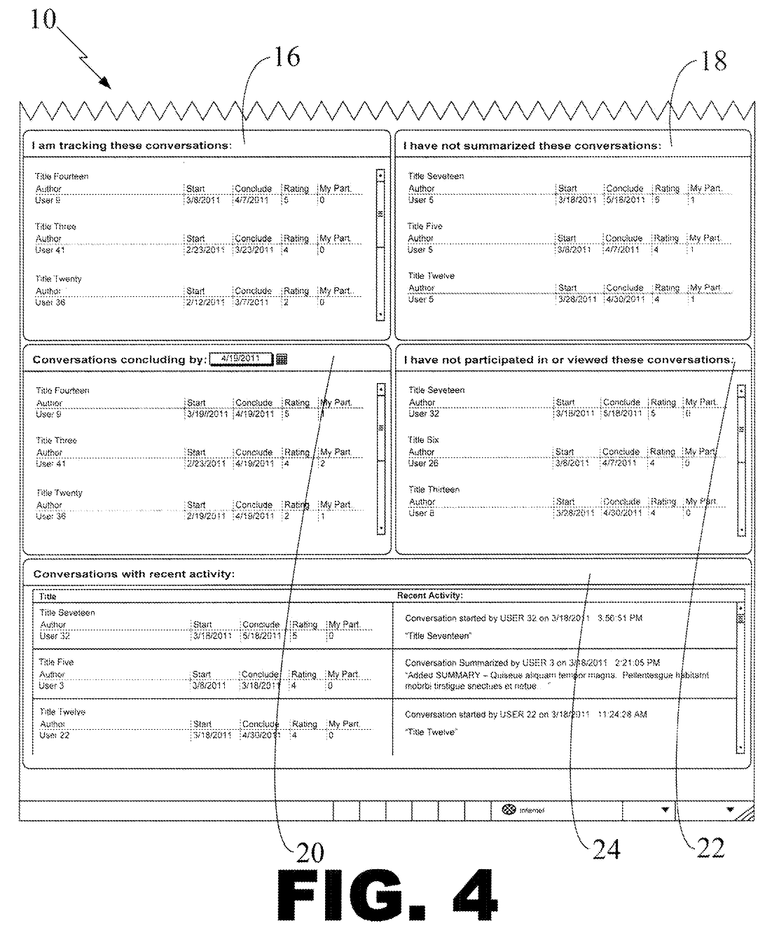

FIG. 4 is a screen shot illustrating one example of the remaining dashboards of the present invention 10. The organization may configure the shown dashboards to contain displays of conversations beneficial to that organization. Shown are the dashboard categories which may be beneficial to a wide variety of organizations. Shown for purposes of explanation are the Tracking Conversations Dashboard 16, the Unsummarized Conversations Dashboard 18, the Concluding Conversations Dashboard 20,the Not Participated or Viewed Conversations Dashboard 22, and the Recent Activity Conversations Dashboard 24. These dashboards supply the user with what the user should be viewing compared to all other conversations within the KM application as well as tasks that need to be completed by the user. The conversations the user is tracking as the user's favorite conversations are the conversations the user would like to monitor. These conversations are displayed within the Tracking Conversations Dashboard 16. The next dashboard shown is the Unsummarized Conversations Dashboard 18. The Unsummarized Conversations Dashboard 18 displays the conversations which the user has authored within the KM application which have reached its conclusion date for feedback by other users. The conversations displayed have not been summarized, as allowed by KM applications, such as WSN INSIGHT. Also shown is the Concluding Conversations Dashboard 20. Here, the user sees a display of all the conversations that the user has been targeted for, or given permissions for, in the KM application, which will be concluding by a date specified by the user. The next dashboard shown is the Not Participated Or Viewed Conversations Dashboard 22. Using this dashboard, the user may see conversations that the user was targeted for but has not participated in or has not viewed or read. The final dashboard shown is the Recent Activity Conversations Dashboard 24. The Recent Activity Conversations Dashboard 24 informs the user of recent activity within the conversations by any user and gives the user a synopsis of the activity. For example, in the Recent Activity Conversations Dashboard 24 the user may see the last feedback that was given and any changes that were made within the conversation.

The conversations list within each dashboard gives the user a quick summary of how many times the user participated in the listed conversations, the authors of the conversations, the authors' title and position within the organization, the conversations' start and conclusion dates, the conversations' rating, as well as the time and date of the most recent activity within the conversations.

The organization may also configure a dashboard to list individual users contributing the majority of knowledge compared to the contributions of other users within a KM application. This list may be based on rankings to conversations and feedback given to a user, the overall rank, and the calculated popularity for the conversations the user has authored

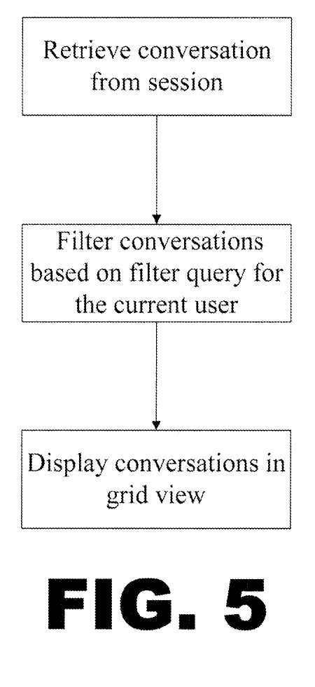

FIG. 5 is a flow diagram illustrating one example of how the dashboard categories are populated based on the organization configured criteria. The present invention first retrieves the conversations from the session, as defined in FIG. 3. Once the conversations have been retrieved, the conversations within the KM application are filtered based on the filter query, based on the current user, within each dashboard. In the examples used for explanation purposes, the first dashboard, conversations the user is tracking, may have a filter which filters all conversations within the KM application to display all conversations that the user is tracking by marking as a favorite conversation. The second dashboard, conversations that the user has authored but not summarized, may have a filter which filters all conversations within the KM application to display all conversations that have not been summarized by the current user. The third dashboard, conversations concluding by a user specified date, may have a filter which filters all conversations within the KM application to display conversations concluding by the given date. The fourth dashboard, conversations the user has not viewed or participated in, may have a filter which filters all conversations within the KM application to display all conversations the current user has not viewed or participated in. The final dashboard in the example, conversations with recent activity, may have a filter which filters all conversations within the KM application to display conversations with recent activity. Once the pertinent filter has provided the required conversations, the conversations are displayed in the grid view.

What is claimed is new and desired to be protected by Letters Patent and is set forth in the appended claims:

1. A Knowledge Dashboard for knowledge sharing and management applications comprising configurable and interactive key performance indicators displaying popular information created and gathered within a knowledge sharing and management application.

2. The Knowledge Dashboard for knowledge sharing and management applications according to claim 1, further comprising a means for displaying of the popular information and content accessible to a user gathered in a knowledge sharing and management.

3. The Knowledge Dashboard for knowledge sharing and management applications according to claim 1, further comprising a means for calculating the popular information created and gathered within a knowledge sharing and management application.

4. The Knowledge Dashboard for knowledge sharing and management applications according to claim 3, wherein said means for calculating the popular information created and gathered within a knowledge sharing and management application comprises creating user configurable elements; assigning weight to said user configurable elements; calculating the weight towards the popularity of each piece of information gathered within a knowledge sharing and management application; and presenting the pieces of information in order of the calculated popularity based on user accessibility to the pieces of information.

5. The Knowledge Dashboard for knowledge sharing and management applications according to claim 4, wherein said user configurable elements include ratings, number of participations, and number of views from all users within a knowledge sharing and management application.

6. The Knowledge Dashboard for knowledge sharing and management applications according to claim 5, wherein said ratings are dependent upon the numerical values information and content are given to information and content within a knowledge management application.

7. The Knowledge Dashboard for knowledge sharing and management applications according to claim 5, wherein said number of participations is dependent upon the total number of participations for all information and content within a knowledge sharing and management application.

8. The Knowledge Dashboard for knowledge sharing and management applications according to claim 5, wherein said number of views is dependent upon the total number of views for all information and content within a knowledge sharing and management application.

9. The Knowledge Dashboard for knowledge sharing and management applications according to claim 1, further comprising filters for filtering user accessible information and content within a knowledge sharing and management application.

10. The Knowledge Dashboard for knowledge sharing and management applications according to claim 9, wherein said filters provide information and content within a knowledge sharing and management application where said information and content is reaching conclusion.

11. The Knowledge Dashboard for knowledge sharing and management applications according to claim 9, wherein said filters provide information and content within a knowledge sharing and management applications where said information and content is tracked by the user.

12. The Knowledge Dashboard for knowledge sharing and management applications according to claim 9, wherein said filters provide information and content within a knowledge sharing and management application where said information and content requires action by the user.

13. The Knowledge Dashboard for knowledge sharing and management applications according to claim 9, wherein said filters provide information and content within a knowledge sharing and management application where said information and content has not been viewed by the user.

14. The Knowledge Dashboard for knowledge sharing and management applications according to claim 9, wherein said filters provide information and content within a knowledge sharing and management application where said information and content has recent activity by users of the knowledge sharing and management application.
